(19) United States
(12) Patent Application Publication
(10) Pub. No.: US 2007/0013466 A1
(43) Pub. Date: Jan. 18, 2007

(54) Ferroelectric varactors suitable for capacitive shunt switching

(76) Inventors: Ken Hersey, Clarksville, MD (US); Khosro Shamsaifar, Ellicott City, MD (US); Louise C. Sengupta, Ellicott City, MD (US)

Correspondence Address: James S. Finn;c/o Bill Tucker, 14431 Goliad Dr. Box #8, Malakoff, TX, 75148, US

(21) Appl. No.: 11/494,066

(22) Filed: Jul. 27, 2006

Related U.S. Application Data
(63) Continuation of application No. 11/045,957, filed on Jan. 28, 2005.
(60) Provisional application No. 60/539,771, filed on Jan. 28, 2004.

(51) Int. Cl. H01P 1/10

(52) U.S. Cl. 333/262

(57) ABSTRACT

An embodiment of the present invention provides an apparatus, comprising a radio frequency switch capable of using tunable dielectric capacitors as the switching element for a plurality of cross connected ports. Further, the RF switching may be accomplished by creating an RF short at a tee within said apparatus by the combination of transmission lines and the impedance provided by the tunable dielectric capacitor.

The present invention relates to ferroelectric varactors, and in particular, to a ferroelectric varactor that is suitable for a capacitive shunt switch.

Electrically tunable microwave filters have many applications in microwave systems. These applications include local multipoint distribution service (LMDS), personal communication systems (PCS), frequency hopping radio, satellite communications, and radar systems. There are three main kinds of microwave tunable filters, mechanically, magnetically, and electrically tunable filters. Mechanically tunable filters are usually tuned manually or by using a motor. They suffer from slow tuning speed and large size. A typical magnetically tunable filter is the YIG (Yttrium-Iron-Garnet) filer, which is perhaps the most popular tunable microwave filter, because of its multioctave tuning range, and high selectivity. However, YIG filters have low tuning speed, complex structure, and complex control circuits, and are expensive.

One electronically tunable filter is the diode varactor-tuned filter, which has a high tuning speed, a simple structure, a simple control circuit, and low cost. Since the diode varactor is basically a semiconductor diode, diode varactor-tuned filers can be used in monolithic microwave integrated circuits (MMIC) or microwave integrated circuits. The performance of varactors is defined by the capacitance ratio, Cₘₐₓ/Cₘᵢₙ, frequency range, and figure of merit, or Q factor at the specified frequency range. The Q factors for semiconductor varactors for frequencies up to 2 GHz are usually very good. However, at frequencies above 2 GHz, the Q factors of these varactors degrade rapidly.

Since the Q factor of semiconductor diode varactors is low at high frequencies (for example, <20 at 20 GHz), the insertion loss of diode varactor-tuned filters is very high, especially at high frequencies (>5 GHz). Another problem associated with diode varactor-tuned filters is their low power handling capability. Since diode varactors are nonlinear devices, larger signals generate harmonics and subharmonics.

Varactors that utilize a thin film ferroelectric ceramic as a voltage tunable element in combination with a superconducting element have been described. For example, U.S. Pat. No. 5,640,042 discloses a thin film ferroelectric varactor having a carrier substrate layer, a high temperature superconducting layer deposited on the substrate, a thin film dielectric deposited on the metallic layer, and a plurality of metallic conductive means disposed on the thin film dielectric, which are placed in electrical contact with RF transmission lines in tuning devices. Another tunable capacitor using a ferroelectric element in combination with a superconducting element is disclosed in U.S. Pat. No. 5,721,194.

With the advent of microelectromechanical system (MEMS) technology, attention has been focused on the development of MEMS devices for radio frequency (RF) applications. MEMS switches are one of the most prominent micromachined products that have attracted numerous research efforts in numerous years and have many potential applications such as impedance matching networks, filters, signal routing in RF system front-end and other high frequency reconfigurable circuits. MEMS switches provide many advantages over conventional electromechanical or solid-state counterparts in terms of low insertion loss, high isolation, low power consumption, high breakdown voltage, high linearity and high integration capability. The majority of todays MEMS switches employ electrostatic actuation and require a high actuation voltage, a major drawback of this type of switch. Recently, high relative dielectric constant Barium Strontium Titanium Oxide (BST) thin-films have been used in RF MEMS switches as a dielectric layer for reducing the actuation voltage requirements as well as improving isolation. Isolation can be improved more than 10 dB using ferroelectric thin-films of BST compared to dielectric materials such as Si₃N₄.

However, RF MEMS switches have several limitations such as, for example, relatively low speed, low power handling capability, required high actuation voltage, low reliability, low switching lifetime and high packaging cost Although improvements are being made in these areas, challenges remain for commercial applications of RF MEMS switches. A ferroelectric varactor based capacitive shunt switch can over come most of the limitations of existing RF MEMS switches.

It is against this background that the present invention is based on a coplanar waveguide (CPW) transmission line shunted by a ferroelectric varactor. The novelty in the implementation comes from the elimination any moving parts for switching and from the elimination of via connections. High resistivity silicon with a SiO₂ layer and a metallic layer deposited on top is used as the substrate. The substrate can be any low-loss microwave substrate such as, for example, Saphire, magnesium oxide, lanthanum aluminate, etc. A ferroelectric thin-film layer is deposited on a patterned bottom metal layer (metal1 layer) for the implementation of the varactor. A top metal electrode (metal2 layer) is deposited on the ferroelectric thin-film layer, and patterned to form a CPW transmission line, such that an overlapping area of the center conductor of the CPW in metal1 and the shorting line in metal2 layers defines the varactor area. By using the large area ground planes in the metal2 layer as well as the metal1 layer, a series connection of the ferroelectric varactor with the large capacitor defined by the ground planes on the top and bottom metal layers was created. The large capacitor acts as a short to ground, eliminating the need for any vias. The concept of switching ON and OFF state is based on the dielectric tunability of the BST thin-films.

Accordingly, it is an object of the present invention to create a varactor shunt switch with improved isolation and insertion loss with reduced bias voltage.

It is another object of the present invention to create a varactor shunt switch with lower bias voltage requirement, high switching speed, ease of fabrication and high switching lifetime.

Other objects of the present invention will be apparent in light of the description of the invention embodied herein.

The following detailed description of specific embodiments of the present invention can be best understood when read in conjunction with the following drawings, where like structure is indicated with like reference numerals and in which:

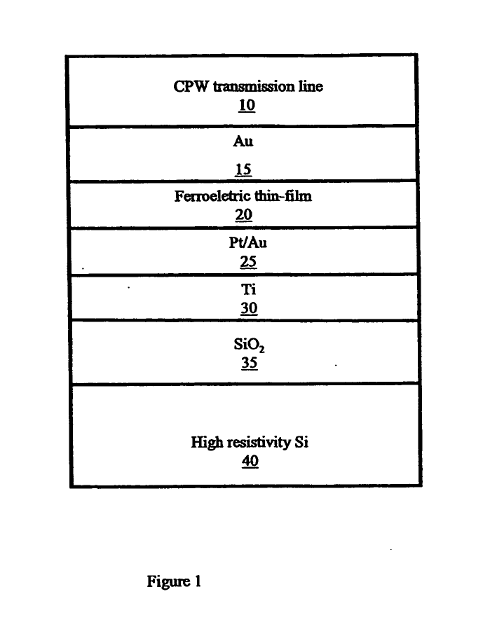

FIG. 1 illustrates a cross-sectional view of the multiple layers of the capacitive shunt switch according to one embodiment of the present invention.

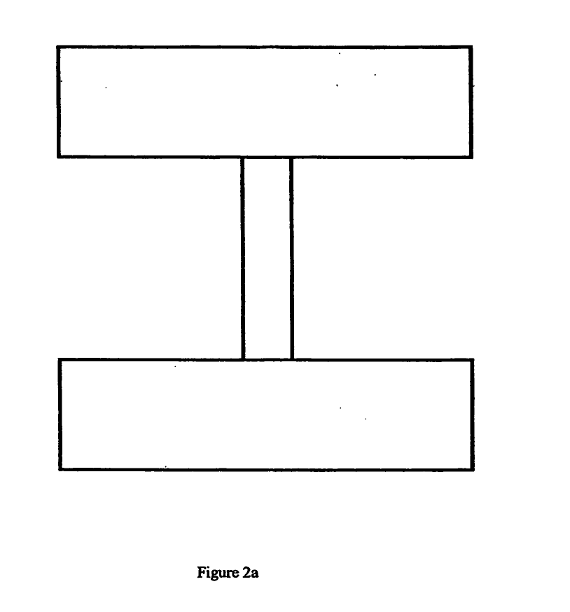

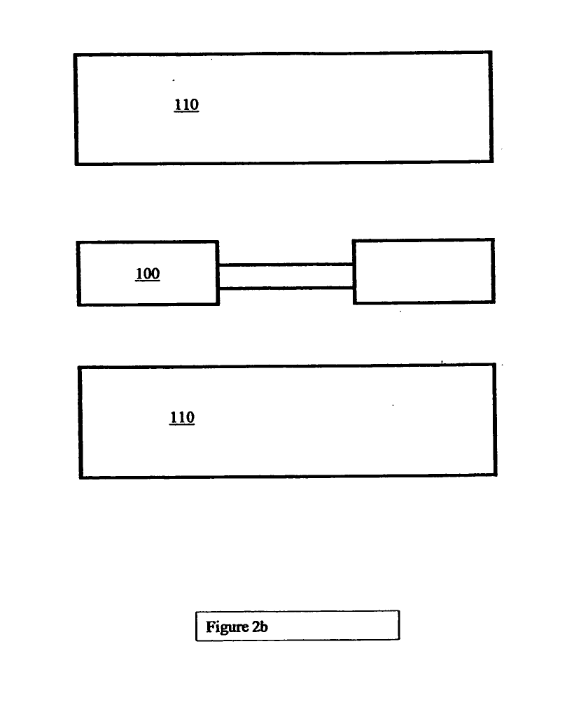

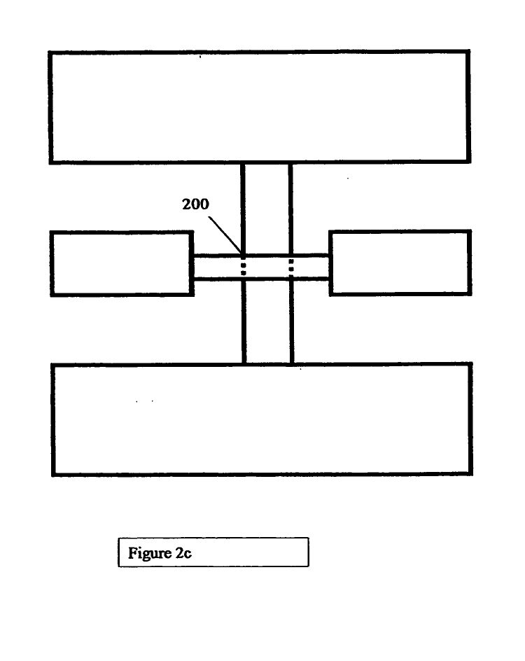

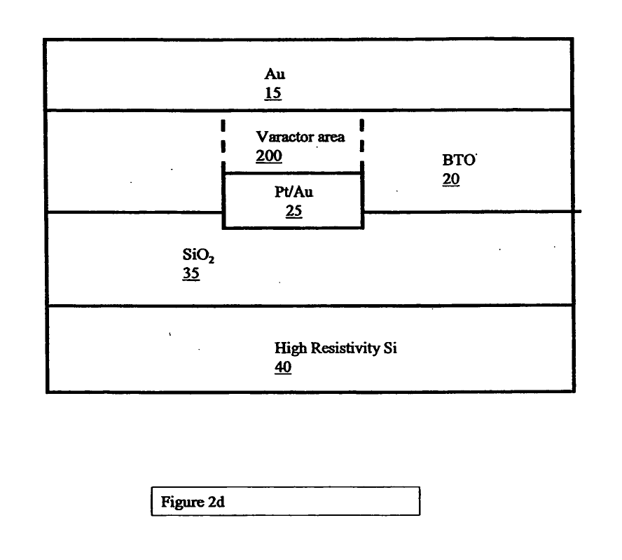

FIG. 2a is a pattern of the bottom metal electrode according to one embodiment of the present invention.

FIG. 2b is a pattern of the top metal electrode according to one embodiment of the present invention.

FIG. 2c is a top-view of a varactor according to one embodiment of the present invention.

FIG. 2d is a cross-sectional view of the varactor area according to one embodiment of the present invention.

FIG. 3 illustrates a top view of the capacitive shunt switch according to one embodiment of the present invention.

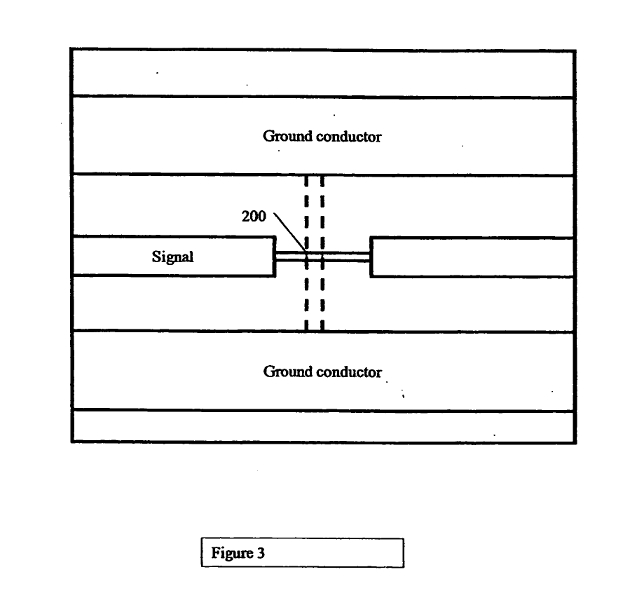

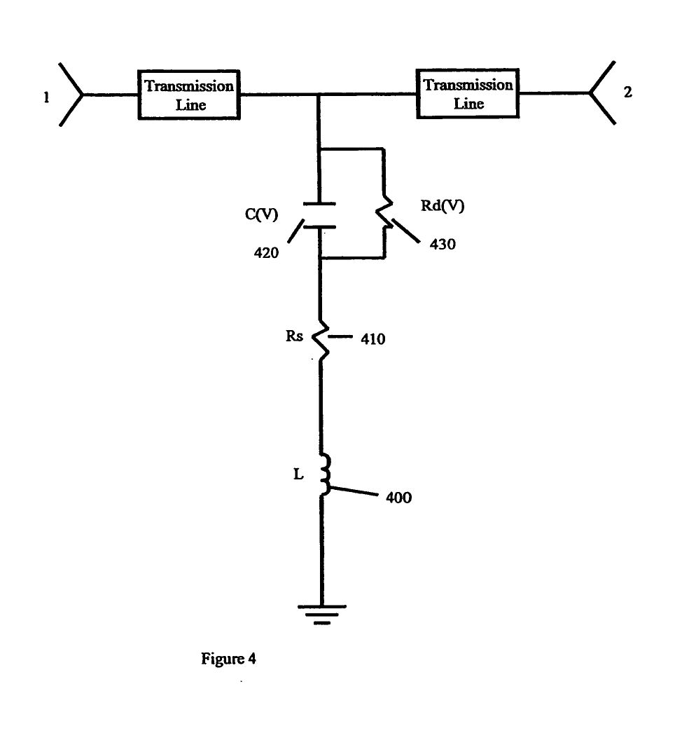

FIG. 4 represents the electric circuit model of the varactor shunt switch of FIG. 3 according to one embodiment of the present invention.

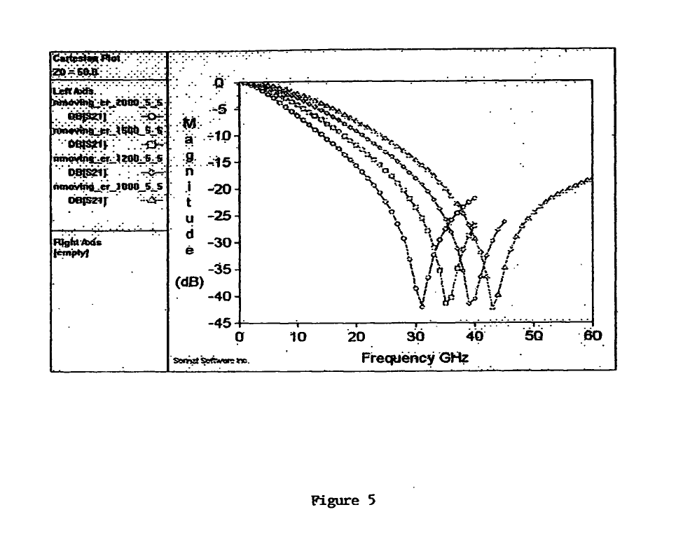

FIG. 5 illustrates simulated isolation using different dielectric constants with the same varactor area according to one embodiment of the present invention.

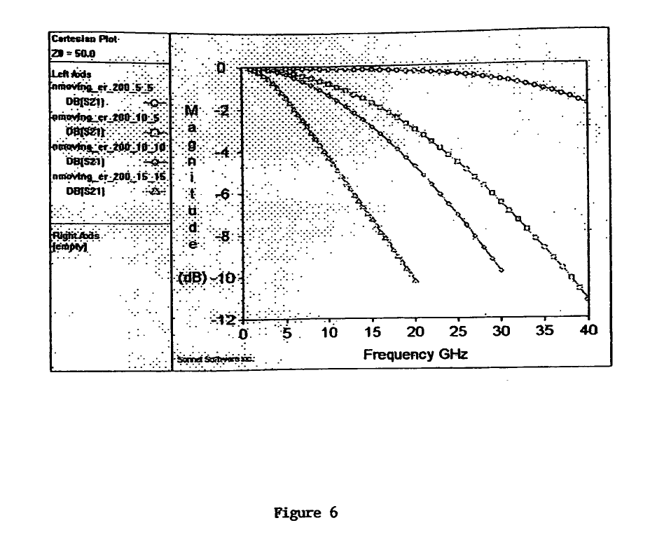

FIG. 6 illustrates simulated insertion loss using different varactor areas with the same dielectric constant according to one embodiment of the present invention.

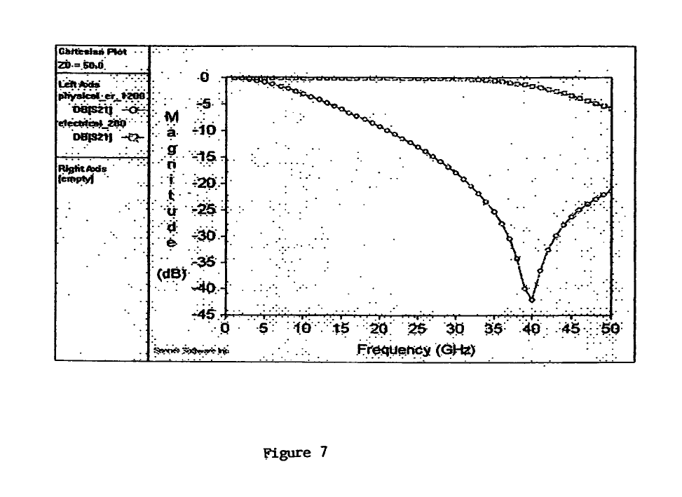

FIG. 7 illustrates simulated isolation and insertion loss of the varactor shunt switch for an optimized device according to one embodiment of the present invention.

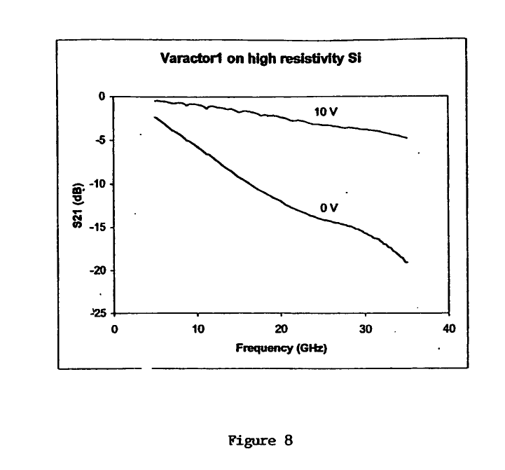

FIG. 8 illustrates experimental measurements on the varactor shunt switch according to one embodiment of the present invention.

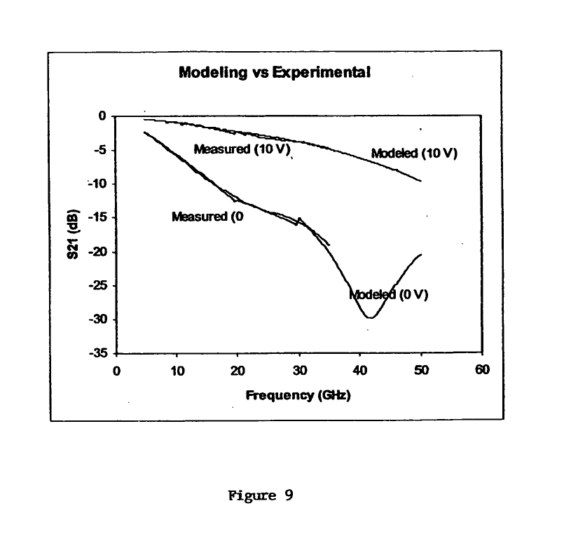

FIG. 9 illustrates experimental results versus the simulation results for the varactor shunt switch according to one embodiment of the present invention.

In the following detailed description of the preferred embodiments, reference is made to the accompanying drawings that form a part hereof, and in which are shown by way of illustration, and not by way of limitations specific preferred embodiments in which the invention may be practiced. It is to be understood that other embodiments may be utilized and that logical, mechanical and electrical changes may be made without departing from the spirit and scope of the present invention.

The concept of implementing shunt capacitance will be useful for a large number of MMICs such as, for example, tunable one-dimensional and two-dimensional electromagnetic bandgap (EBG) structures, tunable band-reject and bandpass fitters, interference suppression systems, microwave switching applications, distributed phase shifters for microwave and millimeterwave frequencies. Furthermore, the present Invention is also suitable for two-dimensional and three dimensional EBG arrays. In addition, these switches could be used in analog and digital applications, such as, for example, interlayer coupling in multi-layered packages, isolation of specific subsystems with a larger system. This type of switch could also serve as a sensory element, since ferroelectric thin-films manifest piezo-electricity (useful for pressure sensors, accelerometers, etc.), pyroelectricity (for infra-red detectors), and electro-optic activity (voltage induced refractive index change for color filters, displays, optical switching, etc.).

FIG. 1 illustrates a cross-sectional view of the multiple layers of the varactor shunt switch. The varactor shunt switch is designed on CPW transmission line 10 with a multilayer substrate. A tunable ferroelectrical thin-film of BST 20 with a high dielectric constant (∈ᵣ24 100) is used as a dielectrical layer (400 nm thickness) on top of the platinum/gold layer 25 with a thickness of 500 nm. A titanium adhesion layer 30 of 20 nm is deposited between the platinum/gold layer 25 and the silicon oxide/high resistivity silicon substrate layer 35 and 40. The silicon has resistivity of 1 kΩ-cm and is typically about 6 kΩ-cm. The thickness of the silicon oxide layer 35 and the high resistivity silicon substrate 40 are 200 nm and 20 mils respectively.

As a first step in the process, a patterned bottom electrode (metal1 layer) is processed on a Si/SiO₂ substrate by electron beam (e-beam) deposition (or sputtering) and lift-off photolithography technique. FIG. 2a shows the pattern of the bottom metallic layer 25. After the lift-off photolithography process for the platinum/gold layer 25, the layer 25 is covered by a 400 nm ferroelectric thin film 20 such as, for example, barium strontium titanate (BST), strontium titanate (STO) or any other non-linear tunable dielectric, using a pulsed laser ablation (PLD) process or by RF sputtering. Note that the ferroelectric thin-film can be used in the paraelectric state or in the ferroelectric state to optimize the switch performance based on the type of application.

FIG. 2b illustrates the pattern of the top metal electrode 15 that is deposited on top of the ferroelectric thin film 20. This top metal electrode 15 is comprised of gold and includes the central signal strip 100 and the ground conductors 110 of the CPW. The top metal electrode 15 is prepared by e-beam deposition (or sputtering) and lift off photolithography process. The ground conductors in the bottom metallic layer 25 and top metal electrode 15 are effectively shorted, due to the large capacitance between these two layers, eliminating need for the via holes.

The top view of the finalized CPW is shown in FIG. 2c. In FIG. 2c, the varactor area 200 is defined by the overlap area between the top metal electrode and the metallic layer indicated by the dashed lines. The bottom metallic layer 20 comprises two ground conductors with exactly the same dimensions as the CPW ground lines and a shunt conductor, connecting the two ground lines in the metal1 layer, seen as the dotted lines in FIG. 3. When the capacitance of the varactor is very high (at 0V bias), the signal is coupled through the varactor and passes through the shunt conductor to the ground. The varactor capacitance is in series with the larger capacitance introduced by the overlapping of the ground conductors in the top metal electrode (metal2) and the bottom metallic layer (metal1). The output is isolated from the input because of the signal being shunted to ground at 0V, resulting in the OFF state of the device. When one applies a dc voltage to the center conductor of the CPW in the metal2 layer, the dielectric constant of the ferroelectric thin-film is reduced and results in a lower varactor capacitance. When the varactor capacitance becomes small, the majority of signal from the input will be passed on to the output, because of reduced coupling by the varactor, resulting in the ON state of the device. Large dielectric tunability results in high isolation and low insertion loss of the device.

In the cross section of the varactor, see FIG. 2d, the widths of the two overlapping top metal electrode 15 and bottom metallic layer 25 are chosen such that a required value of capacitance is obtained based on the known relative permittivity (∈ᵣ) of the ferroelectric thin-film. Tuning is obtained if a DC electric field is applied between the ground conductors and the central signal strip of the CPW (using CPW probes). The DC field changes the relative permittivity of ferroelectric thin-film, and hence the capacitance of the varactor.

In one embodiment, the width of the center signal strip of the CPW and the spacing between the center signal strip and ground conductors were chosen so that the characteristic impedance is close to about 50Ω and the line losses are minimized. The CPW line has the dimensions of Ground-Signal-Ground being 150 μm/50 μm/150 μm for DC-20 GHz on the high resistivity silicon substrate 35. The spacing (S) between the center signal strip and ground conductors is taken as 50 μm and the geometric ration (k=W/(W+2S)) is equal to 0.333 of the CPW line. The device area is approximately 450 μm by 500 μm. The varactor area, which is the overlap of the top metal electrode and the bottom metallic layer is approximately 75 μm².

The simple circuit implementation as the present invention is compatible with Si MMIC technology, wherein the need for vias is eliminated in this two metal layer process. The switch is in the normally “OFF” state compared to MEMS capacitive shunt switches which are in the normally “ON” state. In addition, these switches are capable of switching at ˜30 ns switching speeds, where as the MEMS switches are slower (˜10 μs). Further, a lower bias voltage (<10V) can be used compared to MEMS (40-50V) for switching. The varactor shunt switch can be designed for a bias voltage of less than 2 V.

The design trade between the isolation (OFF-state) and insertion (ON-state) loss depends on the varactor area and the dielectric constant of the BST thin-films. Large varactor area and high dielectric constant are required to get the high isolation but it will increase the insertion loss. To keep the insertion loss at a minimum (<1 dB), the optimized overlapping area and dielectric constant are taken as 25 μm² and 1200 respectively.

FIG. 4 represents the electric circuit model of the varactor shunt switch of FIG. 3. The electrical circuit model is obtained by shunting the varactor, with L 400 and Rs 410 being parasitic Inductance and resistance respectively. The shunt resistance Rd 430 models the lossy (leakage conductance) nature of the varactor. The varactor capitance 420 can be obtained by the standard parallel plate capacitance calculation, with the dielectric permittivity of the BST thin-film, and the overlap area of the center signal strip and the shunt line. The varactor capacitance is given by:
Cv=∈ₒ.∈_{rf}.A/t (1)

Where ∈ₒ is the dielectric permittivity of free space, ∈_{rf} is the relative dielectric constant of the ferroelectric thin-film used, A is the area of the varactor, and t is the thickness of the ferroelectric thin-film.

The series resistance (Rₛ) 410 of the shunt conductor line in the bottom metal layer (metal1), where the signal is shunted to ground is calculated using Equation 2
R=I/(σwt) (2)
where, σ is the conductivity of metal used in the top metal electrode, w is the width of the conductor, l is the length of the line shunting to ground, and t is the thickness of the conductor.

The inductance 400 (L) of the line is calculated using Equation (3)
L=(Zₒ/(2πf)sin(2πl/λ_{g}) (3)
where, Zₒ is the characteristic impedance of the CPW transmission line, f is the operating frequency, and λ_{g} is the guide-wavelength.

The shunt resistance 430 (Rd) of the varactor can be calculated using Equation (4)
Rd(V)=1/(ωC) tan δ) (4)
where, C(V) 420 is the capacitance of the varactor and tan δ is the loss-tangent of the ferroelectric thin-film.

The performance (e.g., high isolation, low insertion loss, etc.) of the capacitive shunt switch depends on the dielectric tunability of the ferroelectric thin-film. High capacitance value will increase the isolation in the OFF-state but it will also increase the insertion loss in the ON-state. The capacitance value can be increased by using a high dielectric constant of the ferroelectric thin-films or large varactor area. Increasing the dielectric constant of the ferroelectric thin-films with same varactor area does not change the isolation very much but the resonance frequency decreases due to the increased varactor capacitance, see FIG. 5. FIG. 5 shows the isolation for the relative dielectric constants of 2000, 1500, 1200 and 1000 from left to right with a fixed varactor area of 5×5 μm².

Further, insertion losses increase with increasing varactor area as shown in FIG. 6. FIG. 6 illustrates the insertion loss for a fixed dielectric constant of value 200 with the varactor areas of 15×15 μm², 10×10 μm², 10×5 μm², and 5×5 μm² from left to right.

The simulated optimized dielectric constant of ferroelectric thin-films is taken as 1200 for the OFF-state and 200 for the ON-state with a varactor area of 5×5 μm², or 25 μm². FIG. 7 illustrates the simulated isolation and insertion loss of the varactor shunt switch for the optimized device. The isolation of the device is better than 30 dB at 30 GHz and the insertion loss is below 1 dB below 30 GHz

The varactor shunt switch was tested using a HP 8510 Vector Network Analyzer (VNA). A line-Reflect-Reflect-Match (LRRM) calibration was performed over a wide frequency range (5 to 35 GHz). The sample was then probed using standard GSG probes. The dc bias was applied through the bias tee of the VNA. FIG. 8 illustrates the experimental measurements performed on the varactor shunt switch for 0 V (i.e., the OFF state) and for 10 V dc bias (i.e., the ON state). In the measured device, the capacitance of the varactor at zero bias was about 0.85 pF and was reduced to about 0.25 pF for a bias voltage of 10 V, thereby, resulting in a dielectric tunability of more than 3:1.

FIG. 9 illustrates the experimental results obtained from the varactor shunt switch compared to the simulation results based on the electrical model developed for the device. The experimental results were obtained up to 35 GHz Theoretical simulations performed on the same device indicates that the isolation (off-state S21) improves to 30 dB near 41 GHz. A good agreement between the theoretical and experimental results over the frequency range of measurements can be seen as shown in FIG. 9. Therefore, the experimental data confirms the operation of the varactor shunt switch for microwave switching applications.

Table 1 demonstrates the comparison among solid-state switching devices, RF MEMS and the ferroelectric-based varactor shunt switch. The advantages of the varactor shunt switch include lower bias voltage requirement, high switching speed, ease of fabrication and high switching lifetime.

TABLE 1

| | | RF MEMS | Ferroelectric |
|---|---|---|---|
| Device characteristics and | Solid state | capacitive shunt | varactor based |
| performance parameter | switches | switches | shunt switch |
| Type of switch | Normally OFF or | Normally ON | Normally OFF |
| | ON | | |
| Actuation voltage | Low (3-8 V) | High (40-50 V) | Low (<10 V) |
| Switching speed | High (5-100 ns) | Low (˜10 μs) | High (<100 ns) |
| Isolation (dB) | <20 db @ 20 GHz | Very high (>40 dB | High (>20 dB @ |
| | | @ 30 GHz) | 30 GHz) |
| Insertion loss (dB) | >1 db @ 30 GHz | Very low (<1 db @ | Low (<1.5 dB @ |
| | | @ 30 GHz) | 30 GHz) |
| Switching lifetime | High | Low | High |
| Packaging cost | Low | High | Low |
| Power handling | Poor (0.5-1 W) | Medium (<5 W) | High (>5 W) |
| Power consumption | Low (1-20 mW) | Almost zero | Almost zero |
| (OFF-state) | | | |
| Breakdown voltage | Low | High | High |
| DC resistance | High (1-5 Ω) | Low (<0.5 Ω) | Low (<0.5 Ω) |
| Linearity | Low | High | High |
| IP3 | Low (˜+28 dBm) | High (˜+55 dBm) | Not available |
| Integration | Very good | Very good | Very good |
| capability | | | |

Note that the ferroelectric varactor shunt switch performance predicted in the table are based on theoretical calculations.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A varactor shunt switch comprising:
a substrate;
a metal electrode deposited on said substrate;
a ferroelectric thin-film deposited on said metal electrode; and
a coplanar waveguide transmission line on top of said ferroelectric thin-film.

2. The varactor shunt switch of claim 1, wherein said substrate is a single layer low loss microwave substrate.

3. The varactor shunt switch of claim 1, wherein said substrate is multilayered.

4. The varactor shunt switch of claim 3, wherein said multilayer substrate comprises:
a high resistivity silicon layer;
a silicon oxide layer on top of high resistivity silicon layer;
an adhesion layer deposited on said silicon oxide layer;
a metallic layer deposited on top of said silicon oxide layer; and
a tunable ferroelectric thin-film dielectric layer coated on top of said metallic layer; and
a top metal electrode defining a coplanar waveguide transmission line.

5. The varactor shunt switch of claim 4, wherein said high resistivity silicon layer has a thickness of about 20 mils.

6. The varactor shunt switch of claim 4, wherein said high resistivity silicon layer has a resistivity of >1 kΩ-cm.

7. The varactor shunt switch of claim 4, wherein said silicon oxide layer has a thickness of about 200 nm.

8. The varactor shunt switch of claim 4, wherein said adhesion layer comprises of titanium.

9. The varactor shunt switch of claim 4, wherein said adhesion layer has a thickness of about 20 nm.

10. The varactor shunt switch of claim 4, wherein said metallic layer further comprises:
a gold layer deposited on said adhesion layer; and
a platinum layer deposited on said gold layer.

11. The varactor shunt switch of claim 10, wherein said gold layer has a thickness of about 400 nm.

12. The varactor shunt switch of claim 10, wherein said platinum layer has a thickness of about 100 nm.

13. The varactor shunt switch of claim 4, wherein said metallic layer has a thickness of about 500 nm.

14. The varactor shunt switch of claim 4, wherein said metallic layer is deposited and lifted off by electron beam deposition and standard lift-off photolithography.

15. The varactor shunt switch of claim 4, wherein said metallic layer is deposited and lifted-off by sputtering and standard lift-off photolithography.

16. The varactor shunt switch of claim 4, wherein said metallic layer comprises of at least two ground conductors and a shunt conductor.

17. The varactor shunt switch of claim 2, wherein said tunable ferroelectric thin-film dielectric layer has a high dielectric constant.

18. The varactor shunt switch of claim 17, wherein said high dielectric constant of said tunable ferroelectric thin-film dielectric layer is greater or equal to about 200 at zero bias.

19. The varactor shunt switch of claim 4, wherein said tunable ferroelectric thin-film dielectric layer has a thickness of about 400 nm.

20. The varactor shunt switch of claim 4, wherein said tunable ferroelectric thin-film dielectric layer is comprised from one of barium strontium titanium oxide, strontium titanate, or combinations of any other nonlinear electric field tunable dielectric thereof.

21. The varactor shunt switch of claim 4, wherein said tunable ferroelectric thin-film dielectric layer is comprised of barium strontium titanium oxide.

22. The varactor shunt switch of claim 4, wherein said tunable ferroelectric thin-film dielectric layer is deposited using pulsed layer deposition.

23. The varactor shunt switch of claim 4, wherein said tunable ferroelectric thin-film dielectric layer is deposited using RF sputtering.

24. The varactor shunt switch of claim 4, wherein a varactor area of said varactor shunt switch is defined by the overlap of said top metal electrode and said patterned bottom metallic layer.

25. The varactor shunt switch of claim 24, wherein said varactor area is between about 1 μm² to about 500 μm².

26. The varactor shunt switch of claim 1, wherein said metal electrode comprises:
a central signal strip; and
at least two ground conductors.

27. The varactor shunt switch of claim 26, wherein said central signal strip has a width of about 50 μm.

28. The varactor shunt switch of claim 26, wherein said at least two ground conductors have a width of about 150 μm.

29. The varactor shunt switch of claim 26, wherein said metal electrode has a spacing between said central signal strip and said at least two ground conductors of about 50 μm.

30. The varactor shunt switch of claim 26, wherein said metal electrode has a spacing that has a geometric ratio equal to about 0.333 of said coplanar waveguide transmission line.

31. The varactor shunt switch of claim 1, wherein said varactor shunt switch is normally in an “OFF” state.

32. The varactor shunt switch of claim 1, wherein said coplanar waveguide transmission line has about 40 to about 50Ω characteristic impedance.

33. The varactor shunt switch of claim 1, wherein said metal electrode is comprised of gold.

34. The varactor shunt switch of claim 1, wherein said metal electrode is deposited and lifted-off using electron-beam deposition and standard lift-off photolithography.

35. The varactor shunt switch of claim 1, wherein said metal electrode is deposited and lifted-off using sputtering and standard lift-off photolithography.

36. The varactor shunt switch of claim 1 has an area of approximately 450 μm by approximately 500 μm.

37. The varactor shunt switch of claim 1 has a parasitic series resistance when a signal is shunted to ground equal to the length of the line shunting to ground divided by the product of the conductivity of said metallic layer, the width of the conductor and the thickness of the conductor.

38. The varactor shunt switch of claim 1 has a parasitic line inductance equal to the characteristic impedance of said coplanar waveguide transmission line divided the product of 2π and the operating frequency multiplied by the sine of the product of 2π and the length of the line shunting to ground divided by the guide-wavelength.

39. The varactor shunt switch of claim 24 has a shunt resistance equal to one divided the product of ω, the capacitance of said varactor area and the loss-tangent of the ferroelectric thin-film.

40. The varactor shunt switch of claim 39, wherein said shunt resistance models the lossy nature of said varactor.

41. A method of fabricating a varactor shunt switch, the method comprising:
depositing an adhesion layer on a high resistivity silicon substrate by electron-beam deposition and lift-off photolithography;
depositing a metallic layer on said adhesion layer by electron-beam deposition and lift-off photolithography;
covering said metallic layer with a layer of ferroelectric thin film by pulsed laser ablation, wherein said metallic layer comprises of at least two ground conductors and a shunt conductor;
topping said layer of ferroelectric thin film with a top metal electrode by electron-beam deposition and lift-off photolithography, wherein said top metal electrode comprises of at least two ground conductor and a center conductor; and
capping said top metal electrode with a coplanar waveguide transmission line comprised of at least two ground conductors and a signal strip.

42. The method of fabricating a varactor shunt switch of claim 41, further comprising:
tuning the capacitance of said varactor shunt switch by applying a dc electric field between said ground conductors of said metallic layer and said top metal electrode and said signal strip of a coplanar waveguide transmission line.
